(19) United States
(12) Patent Application Publication
(10) Pub. No.: US 2014/0233211 A1
(43) Pub. Date: Aug. 21, 2014

(54) LED LUMINAIRES BASED ON COLOR MIXING AND REMOTE PHOSPHOR ARRANGEMENT

(71) Applicants: Peng Chen, Shenzhen (CN); Aiai Li, Shenzhen (CN); Tingming Liu, Shenzhen (CN); Shengmei Zheng, Shenzhen (CN)

(72) Inventors: Peng Chen, Shenzhen (CN); Aiai Li, Shenzhen (CN); Tingming Liu, Shenzhen (CN); Shengmei Zheng, Shenzhen (CN)

(73) Assignee: OSRAM GMBH, Muenchen (DE)

(21) Appl. No.: 14/241,459

(22) PCT Filed: Aug. 9, 2012
(86) PCT No.: PCT/EP2012/065621

§ 371 Date: Apr. 28, 2014

(30) Foreign Application Priority Data
Aug. 30, 2011 (CN) 201110270284.2

(51) Int. Cl. F21K 99/00

(52) U.S. Cl. CPC F21K 9/56
USPC 362/84

(57) ABSTRACT

In various embodiments, a luminaire may include: two or more groups of light emitting elements, each group of light emitting elements having respective wavelength range; and a fluorescence component being capable of generating fluorescence under excitation of the light emitted from said light emitting elements, wherein said fluorescence component is spaced apart from said light emitting elements in a light propagation direction of said light emitting elements, and the light of each group of said light emitting elements is combined with said fluorescence into white light.

### RELATED APPLICATIONS

The present application is a national stage entry according to 35 U.S.C. §371 of PCT application No.: PCT/EP2012/065621 filed on Aug. 9, 2012, which claims priority from Chinese application No.: 201110270284.2 filed on Aug. 30, 2011, and is incorporated herein by reference in its entirety.

### TECHNICAL FIELD

Various embodiments relate to luminaires, in particular to LED luminaires based on color mixing and remote phosphor arrangement.

### BACKGROUND

In recent years, there are a lot of LED (light emitting diode) based luminaires available for various applications like home, shop, street, office, etc. As compared with traditional fluorescent lamps, the LED based luminaires can provide much longer lifetime, higher energy efficiency, and are more environment-friendly.

However, these white LED-based luminaires are still facing a few difficulties that prevent them from more popular uses. The issues include light distribution uniformity, color rendering ability, color stability, efficiency and cost, etc.

In particular, the color rendering indexes (CRI) of the LEDs are usually low, typically in the range of 70-80 for cool white, and 80-90 for warm white.

For example, the existing white LED T8 tube with a transparent cover usually has a CRI of 70-80, and has disadvantages of spotty light distribution and heating-caused color shift.

To improve the color rendering, color mixing is usually used. However, for conventional “white LED+red” color mixing approach, it is difficult to control the color uniformity.

Complicated circuit design is usually needed, and there is color shift due to different thermal-induced degradation behaviors of different types of phosphors (such as yellow phosphor in the white LED and red phosphor).

In addition, the exiting color mixing technique has the following disadvantages:

Mixed color is not uniform and may have bright color spots when there is lack of enough distance to mix the light in the luminaires;

Low light emitting efficiency is caused when a diffusive cover is used to improve light distribution uniformity; and Heating-induced color shift.

As illustrated in FIG. 1A, when a distance between a diffusive fluorescence component and light emitting elements 110, 120 is smaller than d, light emitted from the light emitting elements 110 and 120 reaches the diffusive fluorescence component without mixing, such that bright color spots illustrated in FIG. 1B are generated, and the color and brightness uniformity of the luminaires are influenced. In the Figures, α is representative of light divergence angle of the light emitting elements, and L is representative of a distance between adjacent light emitting elements.

### SUMMARY

Various embodiments provide a luminaire capable of providing improved color rendering, and maintaining uniform light mixing. In various embodiments, a luminaire is provided, the luminaire including: two or more groups of light emitting elements, each group of light emitting elements having respective wavelength range; and a fluorescence component capable of generating fluorescence under excitation of light emitted from the light emitting element, wherein, the fluorescence component is spaced apart from the light emitting elements in the light propagation direction of the light emitting element, and light of each group of light emitting elements is combined with the fluorescence into white light.

In one embodiment of the disclosure, the two or more groups of light emitting elements form an array with a predetermined amount ratio in an interleaving manner.

In one embodiment of the disclosure, the fluorescence component is a cylinder component provided surrounding the light emitting element array.

In one embodiment of the disclosure, the two or more groups of light emitting elements include blue light emitting diode and red light emitting diode, and the fluorescence component has yellow phosphor.

In one embodiment of the disclosure, the amount ratio of the blue light emitting diode to the red light emitting diode is 3:1.

In one embodiment of the disclosure, the two or more groups of light emitting elements include mint light emitting diode and amber light emitting diode.

In one embodiment of the disclosure, a distance d that the fluorescence component spaces apart from the light emitting elements satisfies:

$$d > \frac{L}{2} cot \frac{α}{2}$$

wherein, L is a distance between adjacent light emitting elements, and α is a light divergence angle of the light emitting element.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1A is a schematic view illustrating a light emitting path of an LED for color mixing;

FIG. 1B is an effect view of bright color spot present when the color mixing distance is smaller than the distance d illustrated in FIG. 1A;

FIG. 2A is a perspective view illustrating a configuration example of the luminaires according to an embodiment of the invention;

FIG. 2B is a partial cross sectional view illustrating the luminaires illustrated in FIG. 2A;

FIGS. 3A and 3B are spectrum diagrams of the blue LEDs and red LEDs used in the exemplary embodiments of the disclosure, respectively;

FIGS. 4A and 4B are the phosphor emission spectrum and the distribution diagram of the phosphor powder particle size of the yellow phosphor powder used in the exemplary embodiment of the disclosure, respectively;

FIG. 5A illustrates the spectrum of the white light obtained by color mixing in the remote phosphor arrangement according to the exemplary embodiment of the disclosure;

FIG. 5B illustrates the position of the white light obtained by color mixing in the remote phosphor arrangement according to the exemplary embodiment of the disclosure in the CIE chromaticity diagram;

FIG. 6A is a perspective view illustrating a configuration example of the luminaire having a down light configuration according to another embodiment of the disclosure; and

FIG. 6B is a section view illustrating the luminaire illustrated in FIG. 6A.

### DETAILED DESCRIPTION OF THE DRAWINGS

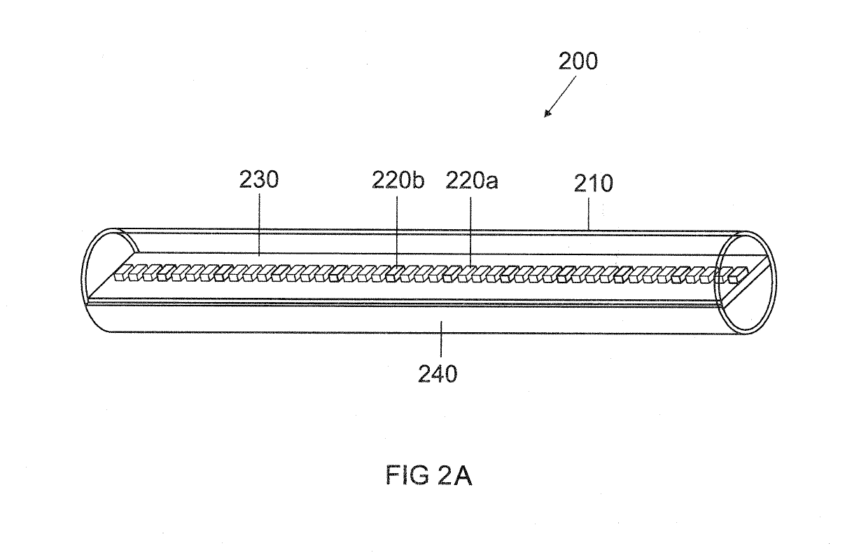

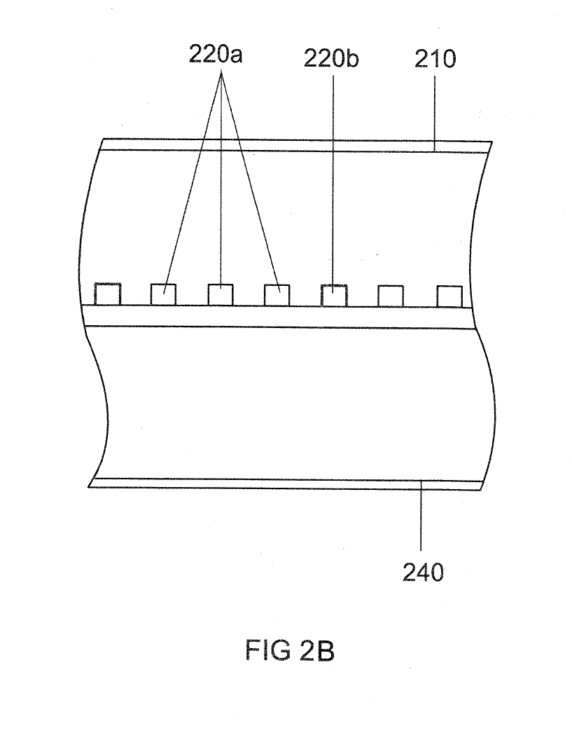

The following detailed description refers to the accompanying drawing that show, by way of illustration, specific details and embodiments in which the disclosure may be practiced. Exemplary embodiments of the invention will be described hereinafter with reference to the Drawings. In the Drawings, same or similar reference signs represent the same or similar sections. To avoid blurring the points of the invention by unnecessary details, only structures and components closely related to the solution of the invention are illustrated and other details having little relations are omitted in the Drawings. FIG. 2A illustrates an example of the configuration of the luminaire according to one embodiment of the invention. A luminaire 200 according to the embodiment of the invention comprises a fluorescence component 210, light emitting elements 220, a circuit board 230 carrying the light emitting elements 220, and a housing 240.

The light emitting elements 220 may comprise two or more groups of light emitting elements, each group of light emitting elements having respective light emitting wavelength range. In the exemplary embodiment, the light emitting elements 220 comprise a group containing a plurality of blue LEDs 220a and a group containing a plurality of red LEDs 220b.

The fluorescence component 210 can generate fluorescence under excitation of light emitted from the light emitting elements 220. For example, the fluorescence component 210 may contain a phosphor which may be incorporated into the fluorescence component 210 by, for example, coating or injection molding. In addition, the light emitted from each group of light emitting elements is combined with the fluorescence of the fluorescence component 210 into white light. In the exemplary embodiment, the fluorescence component 210 includes yellow phosphor powder to thereby combine with light emitted from blue LEDs 220a and red LEDs 220b into white light.

The fluorescence component 210 is spaced apart from the light emitting elements 220 in a light propagation direction of the light emitting elements 220. In the exemplary embodiment, the fluorescence component 210 is of a shape of half-cylinder, and forms a complete cylinder with the housing 240, such that the luminaire 200 as a whole has a shape of a tube. The fluorescence component 210 is spaced apart from the light emitting elements by at least a distance which is approximately a length of the radius of the cylinder in the light propagation direction of the light emitting elements 220, that is, the radial direction of the cylinder.

FIG. 2B illustrates a partial cross section view of the luminaire 200 illustrated in FIG. 2A. The blue LEDs 220a and red LEDs 220b form an array with a predetermined amount ratio. In the illustrated exemplary embodiment, the blue LEDs 220a and the red LEDs 220b are arranged in line with an amount ratio of 3:1 in an interleaving manner. However, in other embodiments, groups of light emitting elements may have different amount ratios, and may be arranged in other manners. For example, the light emitting elements may be arranged as an m×n array, or may be dispersed within a circular region (for example in the down light configuration described latter), etc.

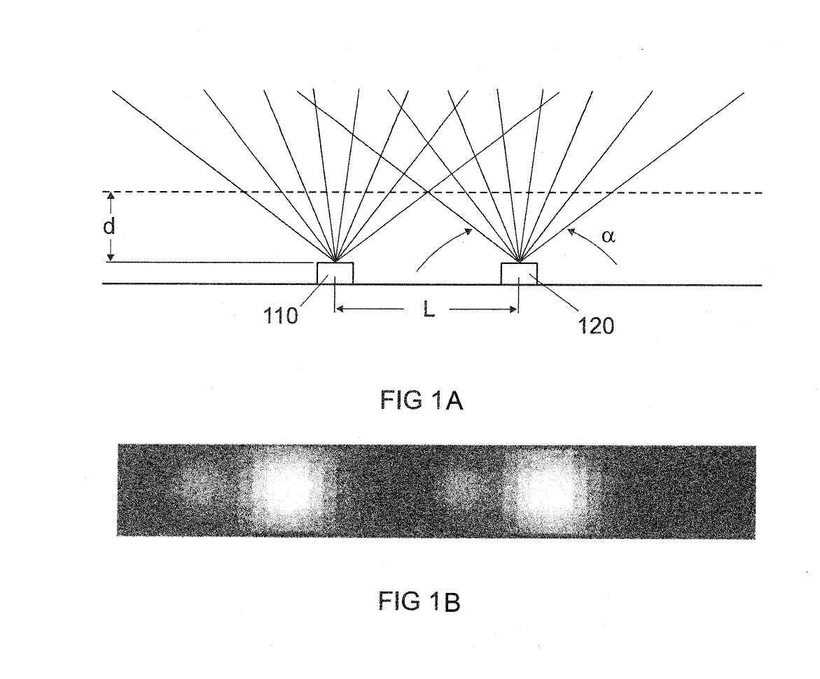

In addition, as described with reference to FIGS. 1A and 1B, the distance d between the phosphor 210 and the light emitting surface of the light emitting elements 220 preferably satisfies the following equitation (1), so as to ensure color mixing uniformity of the luminaire 200 and avoiding the presence of bright color spots:

$$d > \frac{L}{2} cot \frac{α}{2} \qquad ( 1 )$$

wherein L is a distance between adjacent light emitting elements in the light emitting element array, and α is a light divergence angle of the light emitting elements.

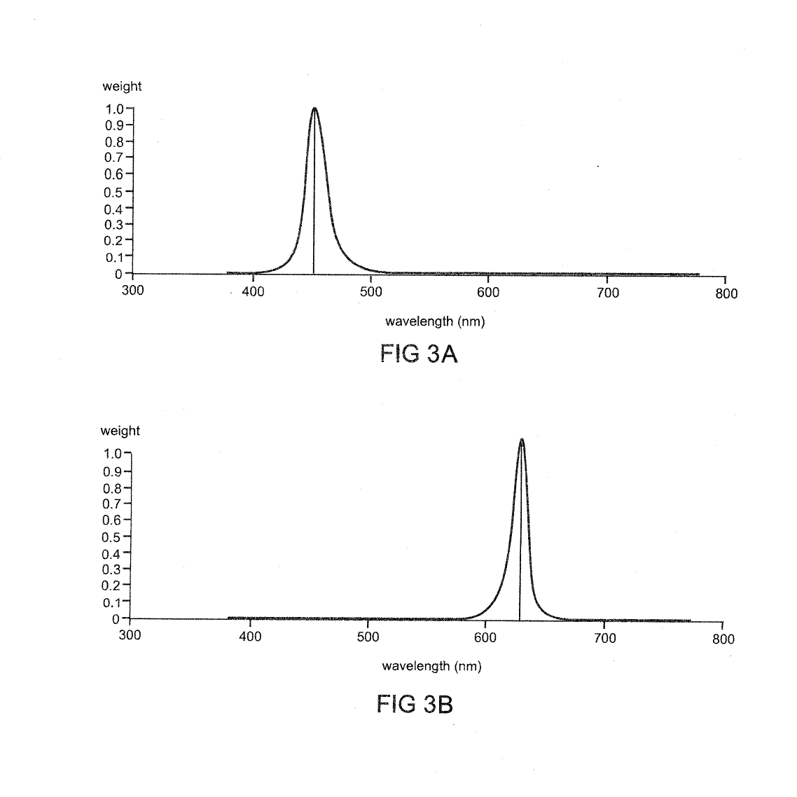

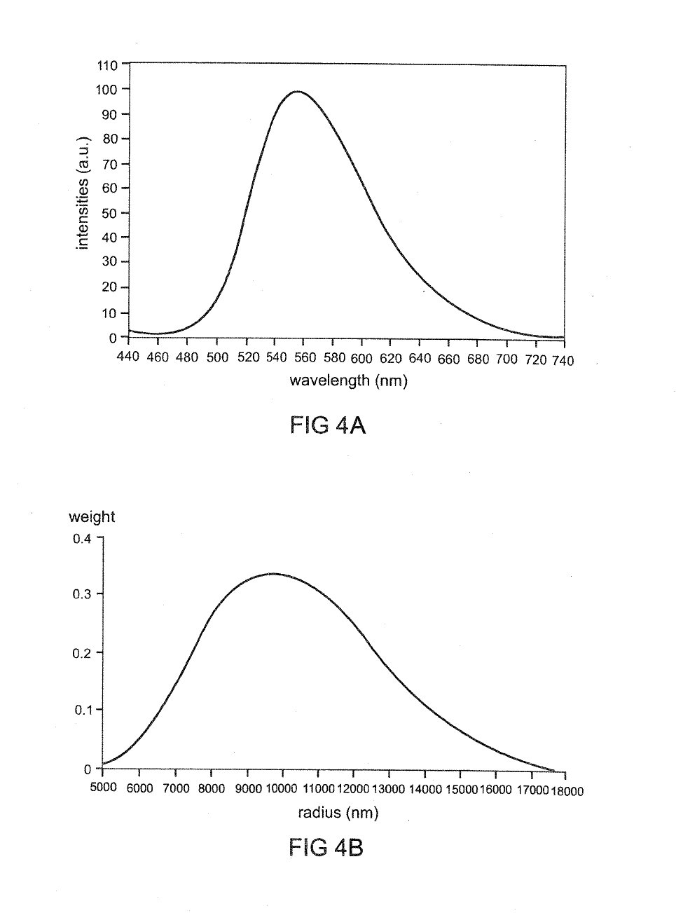

Test results of the luminaire according to a specific embodiment of the disclosure will be described hereinafter in conjunction with a specific example. Wherein, blue LEDs 220a are LTST-T680TBKT type blue LEDs from Liteon Inc., the central wavelength thereof is 453 nm, the full width at half max (FWHM) of the spectrum peak is 21 nm (wavelength range: 442-463 nm), while red LEDs 220b are LTST-T680KRKT type red LEDs from the Liteon Inc., wherein the central wavelength is 631 nm, FWHM is 15 nm (wavelength range 624-639 nm). Wavelength distributions of the blue LEDs and the red LEDs are illustrated in FIGS. 3A and 3B, respectively. The phosphor in the fluorescence component 210 is EY4254 phosphor powder from Internatix Inc., wherein its florescence has a CIE (1931) coordinates of x=0.423, y=0.550, a emission peak at 558 nm, and phosphor powder particle density of 2500/mm³. The phosphor wavelength distribution and particle size distribution of the phosphor powder are illustrated in FIGS. 4A and 4B, respectively.

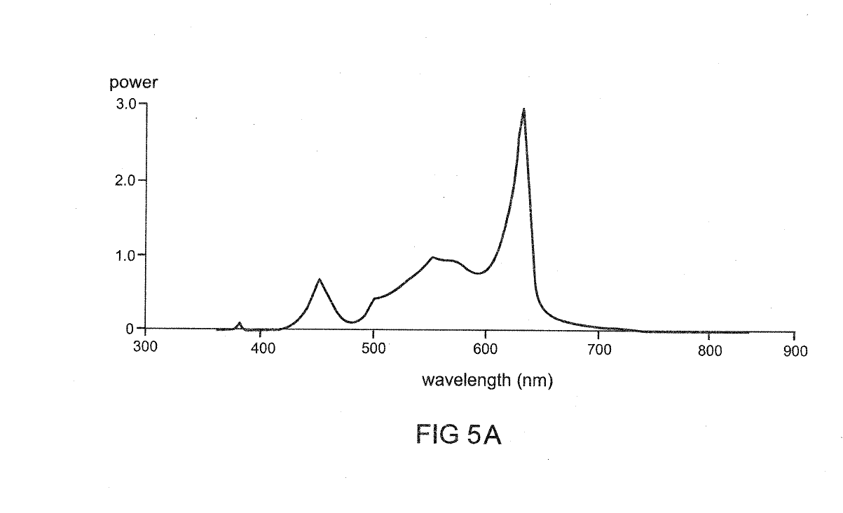

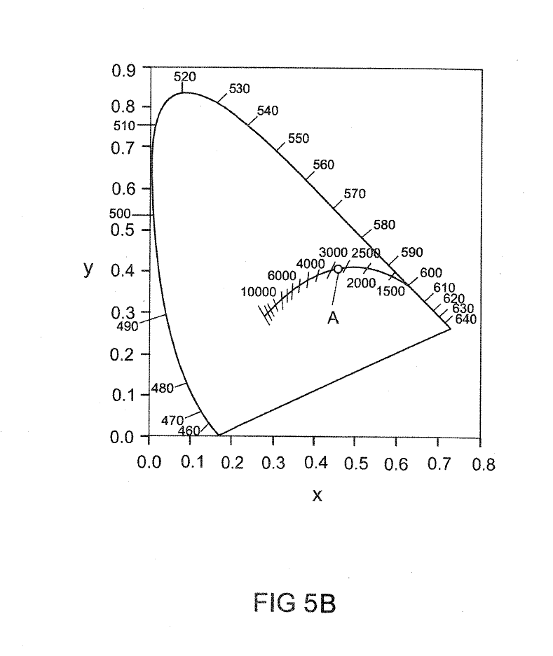

FIG. 5A illustrates the spectrum of the white light obtained by color mixing in the above remote phosphor arrangement. FIG. 5B illustrates the position of the white light obtained by color mixing in the above remote phosphor arrangement in the CIE chromaticity diagram. As indicated by point A in the Figure, the obtained light has coordinates of about x=0.45, y=0.40 in the CIE diagram, having a color temperature of 2717 k which is warm white. R1-R15 rendering indexes of lights obtained by using the luminaire of the exemplary embodiment of the disclosure are listed in the following table 1, from the table it can be obtained that the overall rendering index is 93.458.

TABLE 1
R1-R15 rendering indexes of the lights generated
by the luminaire of the embodiments:

| No. | Standard Test Color Sample | CRI |
|---|---|---|
| 1 | TCS1 [7.5 R 6/4; Light Grayish Red] | 97.698 |
| 2 | TCS2 [5 Y 6/4; Dark Grayish Yellow] | 95.468 |
| 3 | TCS3 [5 GY 6/8; Strong Yellow Green] | 81.467 |
| 4 | TCS4 [2.5 G 6/6; Moderate Yellowish Green] | 92.852 |
| 5 | TCS5 [10 BG 6/4; Light Bluish Green] | 97.330 |
| 6 | TCS6 [5 PB 6/8; Light Blue] | 92.905 |
| 7 | TCS7 [2.5 P 6/8; Light Violet] | 94.250 |
| 8 | TCS8 [10 P 6/8; Light Reddish Purple] | 95.692 |
| 9 | TCS9 [4.5 R 4/13; Strong Red] | 96.565 |
| 10 | TCS10 [5 Y 8/10; Strong Yellow] | 81.471 |
| 11 | TCS11 [4.5 G 5/8; Strong Green] | 93.029 |
| 12 | TCS12 [3 PB 3/11; Strong blue] | 72.728 |
| 13 | TCS13 [5 YR 8/4; Light Yellowish Pink | 99.094 |
| | (Western Complexion)] | |
| 14 | TCS14 [5 GY 4/4; Moderate Olive Green | 86.647 |
| | (Leaf Green)] | |
| 15 | TCS15 [1 YR 6/4; Asian Skin] | 96.730 |

Except for the combination of the blue LEDs and red LEDs described in the above example, the luminaire according to embodiments of the invention may use other light emitting element combinations. For example, a combination of mint LEDs and amber LEDs can be adopted. Specifically the mint LEDs and amber LEDs may be arranged in an array with an amount ratio of 2:1 or 3:1 in an interleaving manner. In addition, since lights of mint LEDs and amber LEDs can be combined into white light, phosphors such as phosphor of yellow or other suitable colors can be adopted.

In addition, combinations of other suitable light emitting elements and phosphor may be selected. For example, referring to the CIE diagram, light emitting elements and phosphor with suitable CIE coordinates can be selected to form white light. Furthermore, although the above description uses an example of two kinds of light emitting elements, more than two kinds of light emitting elements can be used to combine with the phosphor to generate output light having high color rendering.

The above illustrates an exemplary embodiment of a luminaire having a tube form according to the invention, but the luminaire according to the invention may have other forms, like the down light.

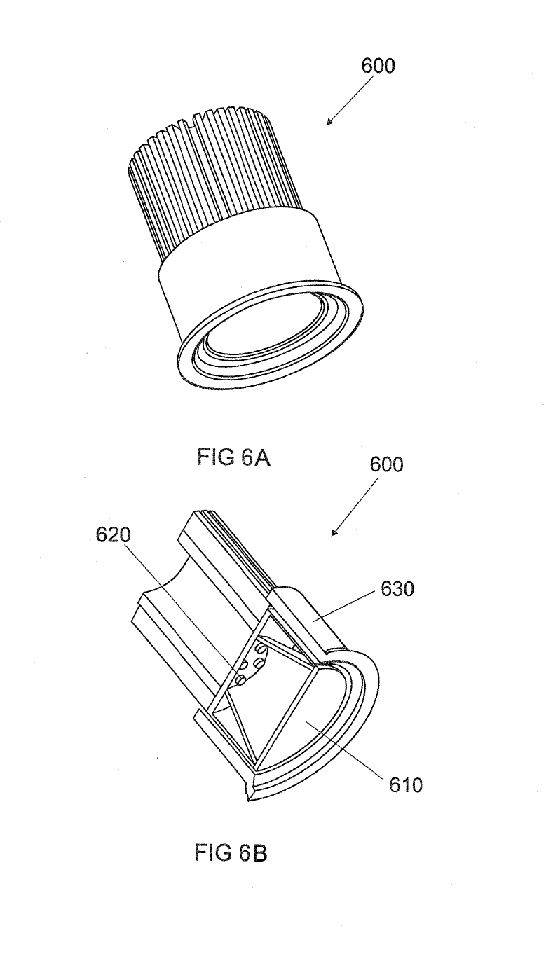

FIGS. 6A and 6B illustrate respectively the perspective view and section view of the luminaire 600 having down light configuration according to another embodiment of the invention.

The luminaire 600 comprises a fluorescence component 610, light emitting elements 620 and a housing 630. Unlike the luminaire 200 having a tube configuration illustrated in FIGS. 2A and 2B, in the luminaire 600 having a down light configuration of the embodiment, the fluorescence component 610 is a circular flat component. Correspondingly, the light emitting elements 620 form a circular array. Suitable arrangement manners can be determined according to the specific selection and amount ratio of the light emitting elements. In addition, the space between the light emitting surface of the light emitting elements 620 and the fluorescence component 610 can be set as above, so as to ensure enough light mixing distance.

Although the light emitting elements are arranged on the same plane in the above embodiments, the invention is not limited thereto. The light emitting elements can be arranged based on specific applications and design requirements, for example, the light emitting elements may be arranged on a curved surface (for example, spherical surface), or on different planes. In addition, the fluorescence component may have different configurations according to specific applications and design requirements as well as the specific arrangement manners of the light emitting elements, as long as the fluorescence component is spaced apart from the light emitting elements in the light propagation direction of the light emitting elements, such that lights from groups of light emitting elements can be mixed sufficiently before reaching the fluorescence component.

With a configuration combining remote phosphor and color mixing, the light emitting elements and the phosphor have sufficient space to obtain uniform light mixing, enabling to implement uniform and stable output light, and enabling to improve color rendering. In addition, such configuration makes it relatively flexible to choose the types of LEDs and phosphors forming the luminaire.

Although embodiments of the invention are described in detail by referring to the Drawings, a person skilled in the art shall understand that various variation, modification, combination and sub-combination of the invention can be made based on design requirements as long as the amendments fall within the spirit and scope of the appended Claims.

1. A luminaire, comprising:
two or more groups of light emitting elements, each group of light emitting elements having respective wavelength range; and
a fluorescence component being capable of generating fluorescence under excitation of the light emitted from said light emitting elements, wherein said fluorescence component is spaced apart from said light emitting elements in a light propagation direction of said light emitting elements, and the light of each group of said light emitting elements is combined with said fluorescence into white light.

2. The luminaire according to claim 1, wherein said two or more groups of light emitting elements form an array with a predetermined amount ratio in an interleaving manner.

3. The luminaire according to claim 2, wherein said fluorescence component is a cylinder component provided surrounding said array.

4. The luminaire according to claim 1, wherein said two or more groups of light emitting elements comprise blue LEDs and red LEDs, and said fluorescence component has yellow phosphor.

5. The luminaire according to claim 4, wherein the amount ratio of said blue LEDs to said red LEDs is 3:1.

6. The luminaire according to claim 1, wherein said two or more groups of light emitting elements comprise mint LEDs and amber LEDs.

7. The luminaire according to claim 1, wherein a distance d that said fluorescence component spaces apart from said light emitting elements satisfies:
$$d > \frac{L}{2} cot \frac{α}{2}$$
wherein, L is a distance between adjacent light emitting elements, and α is light dispersing angle of said light emitting elements.
